(19) United States
(12) Patent Application Publication
(10) Pub. No.: US 2006/0073807 A1
(43) Pub. Date: Apr. 6, 2006

(54) Cellular pedometer

(76) Inventor: Thomas W. Baker, Orefield, PA (US)

Correspondence Address: MANELLI DENISON & SELTER PLLC;7th Floor, 2000 M Street, N.W., Washington, DC, 20036-3307, US

(21) Appl. No.: 10/954,299

(22) Filed: Oct. 1, 2004

(51) Int. Cl. H04M 11/00

(52) U.S. Cl. 455/405; 455/575.1

(57) ABSTRACT

A cellular phone contains a pedometer feature operating from a logging of repeated acceleration measurements, and captures body movements in a similar way as a stand alone pedometer. The acceleration measurements may be taken from a dedicated accelerometer, or from an accelerometer otherwise already integrated into the cell phone for use by any number of other features, including gaming, phone off-hook detection, etc. The pedometer feature may be integrated into a cell phone that includes an accelerometer for other purposes. For instance, in such a cell phone that already includes an accelerometer, a software applet may be downloaded over a data link to the phone to be activated and operate as a pedometer in addition (or instead of) the use of the accelerometer for its original purposes.

### BACKGROUND OF THE INVENTION

1. Field of the Invention

This invention relates to wireless devices. In particular, it relates to features and apparatus available in a wireless device such as a cellular phone.

2. Background of Related Art

The world has been transformed by the emergence of wireless devices, and particularly by the proliferation of cellular phones. The world is also becoming more and more conscious of leading healthy lives, including the need for regular exercise.

Regular exercise may comprise daily jogs, or even just daily walks. To this end, pedometer devices are useful and popular in determining a distance traveled on foot, allowing a user to meet a daily goal, particularly when walking a new route.

A pedometer is a device that measures the number of steps taken by a user. To obtain an accurate distance traveled, the user must calibrate the pedometer with the average distance traveled by each step taken. Multiplying the number of steps taken, by the distance traveled with each step, results in the total distance traveled. Many pedometers, particularly electronic pedometers, allow a user to input a calibration factor into the pedometer as a multiplier to be automatically applied against the number of steps measured, and output or display the distance traveled in a given unit of measurement (e.g., in miles or kilometers).

FIG. 5 shows a typical user of a pedometer.

In particular, FIG. 5 shows a user wearing a pedometer 500. FIG. 5 also shows that the user of the pedometer may be carrying other devices, such as a cell phone 502.

Pedometers may be worn in just about any place, such as at the ankle as shown in FIG. 5, on the belt, placed in a pants or shirt pocket, or even strapped to a bicep. A pedometer records a single stroke or step taken for each measured shock. A pedometer has perhaps the best results when worn at a location that incurs the most shock when walking or running (such as on the ankle), though depending upon the sensitivity of the pedometer, a shock of some sort may be measured from many points of the body.

Pedometers provide a useful measurement or approximation of a distance traveled. Given a need to run or walk as unencumbered as possible, a user may prefer to carry only very desirable or essential items, often leaving out a pedometer. For instance, many runners like to carry a cell phone, if for no other reason than to provide a measure of safety when on long runs. Also, when on ordinary daily errands, a user is probably unlikely to think to wear a pedometer for measurement of distances traveled.

There is a need for providing pedometer functions in a more convenient and efficient manner, particularly for the health conscious, and also particularly for measurements taken throughout a day.

### SUMMARY OF THE INVENTION

In accordance with the principles of the present invention, a feature in a wireless phone comprises counting a number of repeated accelerations of an accelerometer in the wireless phone. The counted number of repeated accelerations are converted into a total distance traveled by a user of the wireless phone.

A wireless phone in accordance with another aspect of the invention comprises a wireless phone functionality module. An accelerometer is mounted in the wireless phone. A pedometer analyzer module is connected to an output of the accelerometer.

A method of determining a distance traveled by a user of a wireless phone on foot in accordance with yet another aspect of the present invention comprises counting, in a wireless phone carried by the user, a number of repeated accelerations of an accelerometer. The counted number of repeated accelerations are translated into a total distance traveled by the user.

### BRIEF DESCRIPTION OF THE DRAWINGS

Features and advantages of the present invention will become apparent to those skilled in the art from the following description with reference to the drawings, in which:

FIG. 1 shows a pedometer module integrated into a cell phone including an accelerometer, in accordance with the principles of the present invention.

FIG. 2 shows a cell phone display including an integrated pedometer function, in accordance with the principles of the present invention.

FIG. 3 shows an analysis of pedometer statistics possible with a computing module and memory capacity storing pedometer readings over a period of days and even weeks, in accordance with the principles of the present invention.

FIG. 4 shows a cell phone including a pedometer function that operates from an accelerometer used for other purposes within the cell phone, such as for a game application and/or to permit automatic off-hook detection upon movement of the cell phone, in accordance with the principles of the present invention.

FIG. 5 shows a typical user of a pedometer.

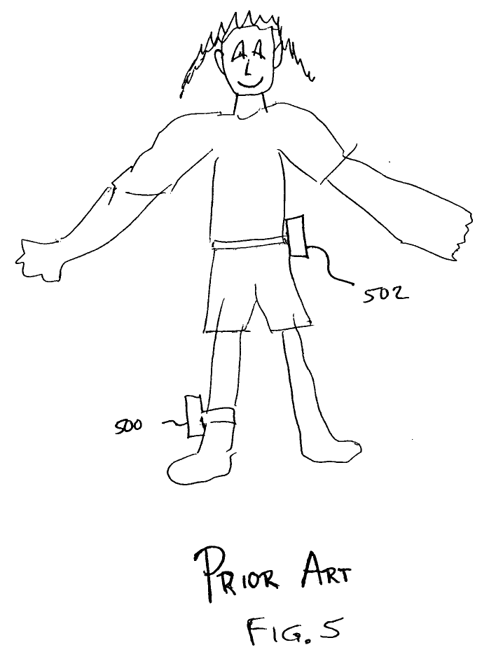

### DETAILED DESCRIPTION OF ILLUSTRATIVE EMBODIMENTS

The present invention allows efficient and unobtrusive measurement of distances traveled without requiring a user to wear a separate pedometer device. The invention allows health conscious people to naturally track exercise logistics, over long periods of time even outside of regimented exercise time (such as walking around the office, through a shopping mall, etc.)

Conventional pedometers require a user to wear a separate pedometer device. A user must make a conscious decision and effort to wear a pedometer. Most users don't wear a pedometer throughout a day, at best wearing a pedometer only when out for a jog or other regimented exercise activity.

The present invention integrates a pedometer into a device that is more often carried or worn by a user throughout a day, i.e., a cell phone. Integration of the pedometer with a cell phone also allows tracking of exercise logistics throughout a day, as long as the user is carrying their cell phone.

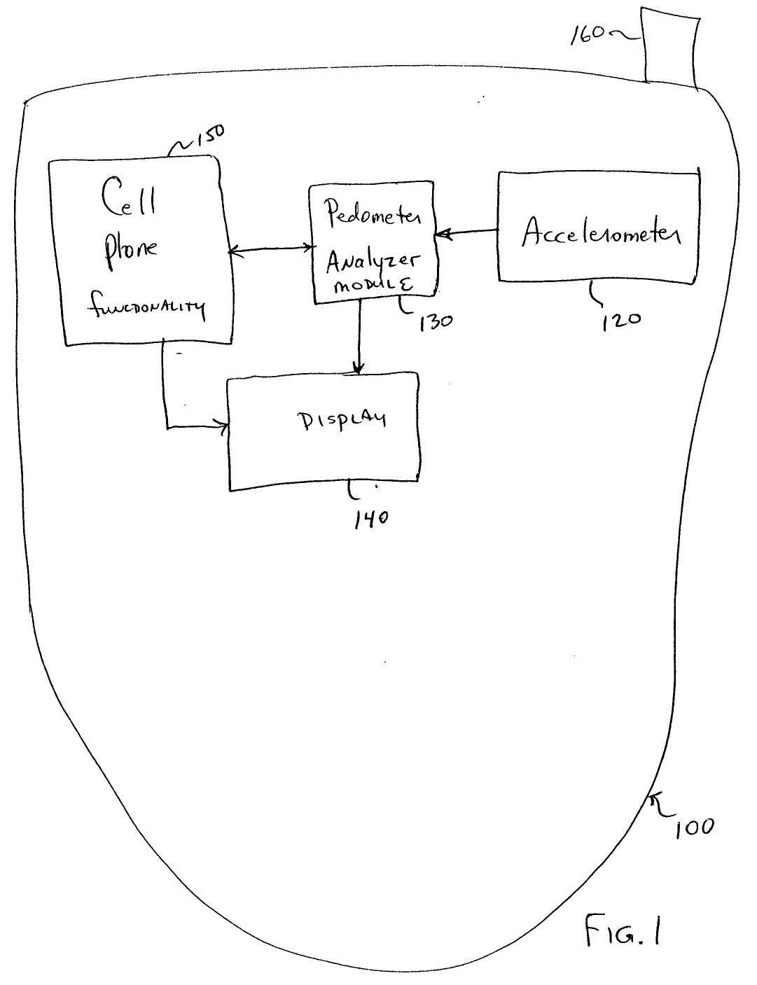

FIG. 1 shows a pedometer module integrated into a cell phone including an accelerometer, in accordance with the principles of the present invention.

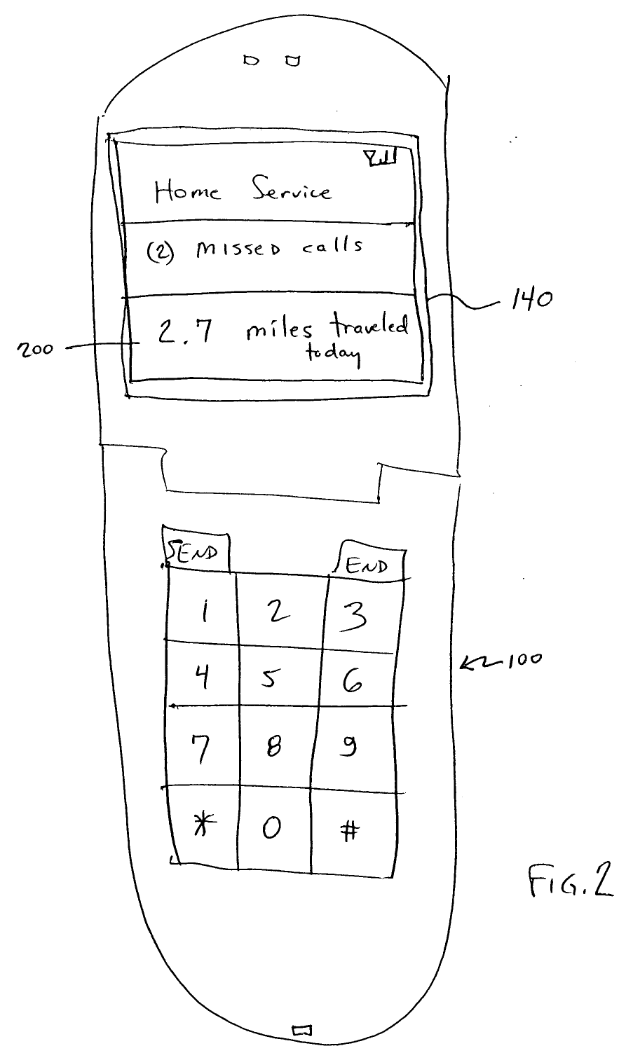

In particular, FIG. 1 shows a cell phone 100 including otherwise conventional cell phone functionality 150, and an LCD display 140. In accordance with the principles of the present invention, an accelerometer 120 is included within the cell phone (or plugged into an appropriate port such as in an expansion memory card port). A pedometer analyzer module is loaded into system memory so as to be operable in the background. Ideally, the pedometer application can be made operable even when the cell phone is placed in a standby mode (e.g., when the flip cover is flipped shut). The pedometer analyzer module 130 may be started using conventional keypad buttons on the cell phone 100 (shown in FIG. 2) in a same manner as any conventional application operating on the cell phone.

The pedometer analyzer module 130 may be integrated within the operating software of the cell phone 100, or may be a separately loaded software application such as a JAVA based applet.

The cell phone may be any cell phone, though most preferably it is a cell phone that is capable of running software applets. For instance, a cell phone running a SMARTPHONE™ operating system allows loading of a software applet containing a pedometer analyzer module 130.

FIG. 2 shows a cell phone display including an integrated pedometer function, in accordance with the principles of the present invention.

In particular, FIG. 2 shows an exemplary display of pedometer derived information in display portion 200 on a cell phone 100. In particular, for example, the pedometer analyzer module 130 may automatically reset a running total distance measurement at the start of each day (e.g., at 12:01 am), and continually display the running total distance on the display 140 of the cell phone 100. In this example, the pedometer has recorded enough leg steps to result in a measurement of 2.7 miles traveled.

Certainly other displays are possible other than the textual display of the number of miles traveled in the day as shown in FIG. 2. For instance, a number may be shown in a small area of the display 140, or even more ideally the distance traveled may be additionally or alternatively shown on the backside of the flip portion of the phone, visible to the user when the cell phone is flipped closed.

An intelligent pedometer may be implemented in ways not currently possible in conventional pedometer devices. For instance, a pedometer with a high power processor and high resolution display is not commercially viable, as it would be extremely expensive. However, when integrated into a cell phone, the expense is already borne by the cell phone user, so the expense is negligible.

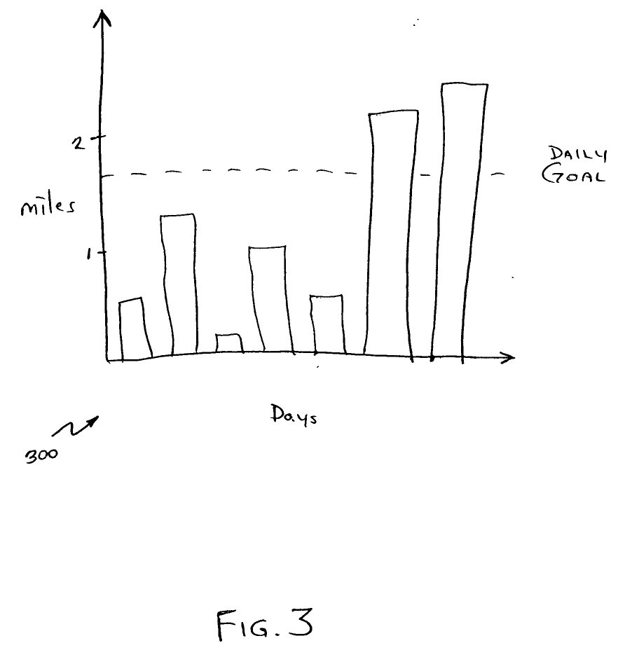

As an example, FIG. 3 shows an analysis of pedometer statistics possible with a computing module and memory capacity storing pedometer readings over a period of days and even weeks, in accordance with the principles of the present invention.

In particular, FIG. 3 shows that distance traveled statistics can be compiled and displayed in any suitable fashion, such as in a bar graph as shown. In the exemplary bar graph, the number of miles traveled per day is plotted against a most recent 7 days. Other information may be displayed, such as an indication as to a daily goal of distance traveled, as customized in a setup menu by the user.

Thus, any type plot or graphical display (e.g., pie chart, scatter plot, bar graph, etc.) may be used to present pedometer derived statistics to a user of the cell phone 100.

The pedometer statistics may also be uploaded to a central server for logging and/or processing. For instance, the cell phone 100 may log pedometer statistics and periodically, or upon manual instruction, upload the same to a central server, which can compile statistics for individuals or on a population of users as a whole. A promotional gimmick may be constructed that ties prizes to a largest distance traveled by an individual user or given group of users.

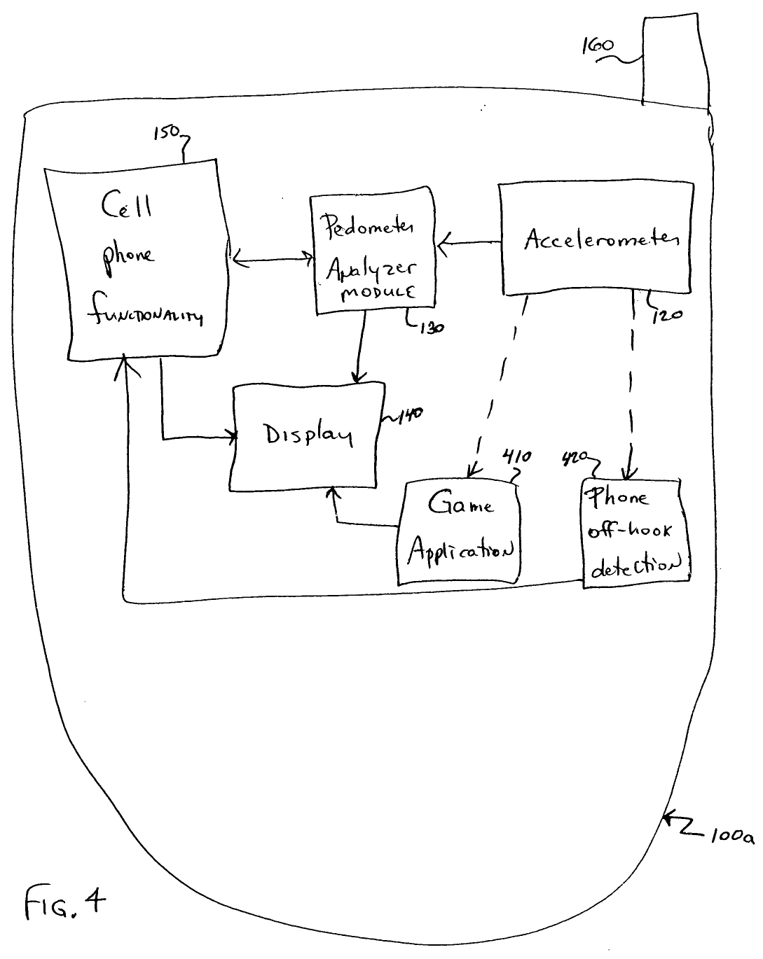

FIG. 4 shows a cell phone including a pedometer function that operates from an accelerometer used for other purposes within the cell phone, such as for a game application and/or to permit automatic off-hook detection upon movement of the cell phone, in accordance with the principles of the present invention.

In particular, FIG. 4 shows that the accelerometer 120 may be one that is already integrated into the cell phone 100a. For instance, an accelerometer 120 used for a particular game application 410, or for automatic off-hook detection 420, may be corralled for usage for an additional application, i.e., for use by a pedometer analyzer module 130. The accelerometer can feed multiple applications simultaneously, so there is no need to halt an application already making use of the accelerometer.

Measurements of accelerations from the accelerometer 120 may be filtered so as to determine ‘steps’ being taken by the user as opposed to mere movement of the phone in a stationary user position. For instance, a series of measurements taken over a period of time (e.g., 5 seconds, 30 seconds, etc.) may be filtered to determine a cadence to the accelerations. A closeness of the measured accelerations to that cadence may be determined, and a threshold set by the factory or user as to what constitutes accelerations likely due to real steps being taken by the user, and what doesn't.

Thus, in accordance with the principles of the present invention, a cellular phone contains a pedometer feature operating from a logging of repeated acceleration measurements, and captures body movements in a similar way as a stand alone pedometer. The acceleration measurements may be taken from a dedicated accelerometer, or from an accelerometer otherwise already integrated into the cell phone for use by any number of other features, including gaming, phone off-hook detection, etc.

The present invention allows for more efficient usage of a pedometer when exercising, as there is one less device (a separate pedometer) to carry. Moreover, body movements may be logged over time, over a series of workouts, over portions of a user's day such as when they are at the office, etc.

Integration of a pedometer function into a cell phone allows a pedometer the extremely powerful abilities of a high end processor integral to a cell phone, as well as the large, expandable memory capabilities of the cell phone, without the separate costs of integrating the same into a separate pedometer.

The pedometer feature may be integrated into a cell phone that includes an accelerometer for other purposes. For instance, in such a cell phone that already includes an accelerometer, a software applet may be downloaded over a data link to the phone to be activated and operate as a pedometer in addition (or instead of) the use of the accelerometer for its original purposes.

The present invention has applicability to entertainment devices as well, such as those that play pre-recorded entertainment data files or streams having dynamic compute cycle requirements. Examples are MP3 players, DVD players, digital video recorders/players, etc.

While the invention has been described with reference to the exemplary embodiments thereof, those skilled in the art will be able to make various modifications to the described embodiments of the invention without departing from the true spirit and scope of the invention.

What is claimed is:

1. In a wireless phone, a feature comprising:
counting a number of repeated accelerations of an accelerometer in said wireless phone; and
converting said counted number of repeated accelerations into a total distance traveled by a user of said wireless phone.

2. In the wireless phone according to claim 1, the feature further comprising:
associating each of said counted number of repeated accelerations with a corresponding distance traveled by said user.

3. In the wireless phone according to claim 1, the feature further comprising:
logging a counted number of repeated accelerations over a plurality of days.

4. In the wireless phone according to claim 3, the feature further comprising:
plotting said counted number of repeated accelerations in a graph; and
displaying said graph on a display of said wireless phone.

5. In the wireless phone according to claim 1, the feature further comprising:
logging a counted number of repeated accelerations over a plurality of weeks.

6. A wireless phone, comprising:
a wireless phone functionality module;
an accelerometer mounted in said wireless phone; and
a pedometer analyzer module connected to an output of said accelerometer.

7. The wireless phone according to claim 6, further comprising:
a game module utilizing output from said accelerometer.

8. The wireless phone according to claim 6, further comprising:
an automatic off-hook detection module utilizing output from said accelerometer.

9. The wireless phone according to claim 6, further comprising:
a display;
wherein distances determined by said pedometer analyzer module based on input caused by repeated accelerations of said accelerometer are presented to a user of said wireless phone through said display.

10. The wireless phone according to claim 6, further comprising:
a distance log containing a plurality of entries each associated with a distance traveled during a given period of time.

11. The wireless phone according to claim 6, wherein:
said given period of time is one day.

12. A method of determining a distance traveled by a user of a wireless phone on foot, said method comprising:
counting, in a wireless phone carried by said user, a number of repeated accelerations of an accelerometer; and
translating said counted number of repeated accelerations into a total distance traveled by said user.

13. The method of determining a distance traveled by a user of a wireless phone on foot according to claim 12, said method further comprising:
associating each of said counted number of repeated accelerations with a corresponding distance traveled by said user.

14. The method of determining a distance traveled by a user of a wireless phone on foot according to claim 13, said method further comprising:
allowing adjustment of said corresponding distance retroactively, based on a comparison of said translated total distance and an actual distance traveled.

15. The method of determining a distance traveled by a user of a wireless phone on foot according to claim 12, said method further comprising:
uploading pedometer data collected by said wireless phone to a centralized database.

16. The method of determining a distance traveled by a user of a wireless phone on foot according to claim 15, said method further comprising:
remotely analyzing pedometer data relating to a given user, and downloading a result of said analysis to said given user's wireless phone.

17. The method of determining a distance traveled by a user of a wireless phone on foot according to claim 12, wherein:
said accelerometer is integrated into said wireless phone.

18. Apparatus for determining a distance traveled by a user of a wireless phone on foot, comprising:
means for counting, in a wireless phone carried by said user, a number of repeated accelerations of an accelerometer; and
means for translating said counted number of repeated accelerations into a total distance traveled by said user.

19. The apparatus for determining a distance traveled by a user of a wireless phone on foot according to claim 18, further comprising:
means for associating each of said counted number of repeated accelerations with a corresponding distance traveled by said user.

20. The apparatus for determining a distance traveled by a user of a wireless phone on foot according to claim 19, further comprising:
means for allowing adjustment of said corresponding distance retroactively, based on a comparison of said translated total distance and an actual distance traveled.

21. The apparatus for determining a distance traveled by a user of a wireless phone on foot according to claim 18, further comprising:
means for uploading pedometer data collected by said wireless phone to a centralized database.

22. The apparatus for determining a distance traveled by a user of a wireless phone on foot according to claim 21, further comprising:
means for remotely analyzing pedometer data relating to a given user, and downloading a result of said analysis to said given user's wireless phone.

23. The apparatus for determining a distance traveled by a user of a wireless phone on foot according to claim 18, wherein:
said accelerometer is integrated into said wireless phone.
